(19) United States
(12) Patent Application Publication
(10) Pub. No.: US 2009/0058143 A1
(43) Pub. Date: Mar. 5, 2009

(54) SCUFF PLATE MODULAR ASSEMBLY FOR VEHICLE LIFTGATE

(76) Inventors: Richard A. Manning, Sterling Heights, MI (US); William G. Yadon, Troy, MI (US); Robert J. Faubert, Shelby Twp., MI (US); Phillip J. Lewis, Rochester, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/847,425

(22) Filed: Aug. 30, 2007

(51) Int. Cl. B60J 9/00

(52) U.S. Cl. 296/199; 296/146.9

(57) ABSTRACT

A vehicle scoff plate assembly may have an outer closure panel, an inner closure panel fastened to the outer closure panel, a first striker mounting bracket fastenable to the inner closure panel, a first striker mounted to the first striker mounting bracket, and a scuff plate fastened to the outer closure panel that surrounds the first striker. A second striker mounting bracket is fastenable to the inner closure panel and a second striker is mountable to the second striker mounting bracket. The second striker mounting bracket is configured in a different angular position to orient the second striker in a different position than the first striker. The inner closure panel and outer closure panel both mount to the vehicle underbody. With different striker mounting brackets mountable to the inner closure panel, a standard vehicle underbody may be utilized and result in fewer or no vehicle underbody production line changes.

### FIELD

The present invention relates to a modular vehicle liftgate structure.

### BACKGROUND

Certain styles of modem vehicles utilize a rear liftgate that employs a latch, and an associated striker that mates with the latch upon dosing of the liftgate. While such liftgate structures have generally proven satisfactory for their given applications, they are not without their share of limitations. One such limitation of existing liftgate structures is that different striker positions are required for different liftgates among different vehicle body styles that utilize many of the same underbody components or much of the same vehicle platform. Because the striker and associated striker mounting components are part of the underbody components or platform, vehicle production lines must be changed to different platforms when a different body style is produced. Changing vehicle platforms to assemble different body styles on the same production line is time consuming and expensive.

What is needed then is a device that eliminates changing vehicle platforms on a single production line when a different body style employing a liftgate is desired to be assembled when the different vehicles utilize much of the same platform.

### SUMMARY

A vehicle scuff plate assembly may have an outer closure panel, an inner closure panel fastened to the outer closure panel, a first striker mounting bracket fastenable to the inner closure panel, a first striker fastened to the first striker mounting bracket, a second striker mounting bracket fastenable to the inner closure panel, and a second striker fastened to the second striker mounting bracket. Furthermore, a scuff plate may be fastened to the outer closure panel that surrounds the first striker.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a rear view of a vehicle employing a rear liftgate and striker according to the invention;

FIG. 2 is a perspective view from the rear of a vehicle depicting an outer closure panel and an inner closure panel according to the invention;

FIG. 3 is a perspective view from an interior of a vehicle depicting an inner closure panel and an outer closure panel according to the invention;

FIG. 4 is a perspective view from an interior of a vehicle depicting a scuff plate and a lip for a weather seal according to the invention;

FIG. 5 is a perspective view from an interior of a vehicle depicting a scuff plate, a lip for a weather seal, and inner and outer closure panels according to the invention;

FIG. 6 is a perspective view from an exterior of a vehicle depicting a scuff plate, a lip for a weather seal, and inner and outer closure panels according to the invention;

FIG. 7 is a perspective view from an interior of a vehicle depicting a striker mounting bracket fastened to an inner closure panel according to the invention;

FIG. 8 is a perspective view from an interior of a vehicle depicting a striker mounting bracket fastened to a weather seal lip bracket;

FIG. 9 is a perspective view from an interior of a vehicle depicting a striker and a striker mounting bracket fastened to a weather seal lip bracket;

FIG. 10 is a side view of a striker mounting bracket and striker;

FIG. 11 is a perspective top view of a striker mounting bracket and striker;

FIG. 12 is a diagram depicting liftgate pivot locations relative to exemplary striker position; and

FIG. 13 is an enlarged side view of exemplary striker and striker mounting bracket positions relative to the inner and outer closure panels.

### DETAILED DESCRIPTION

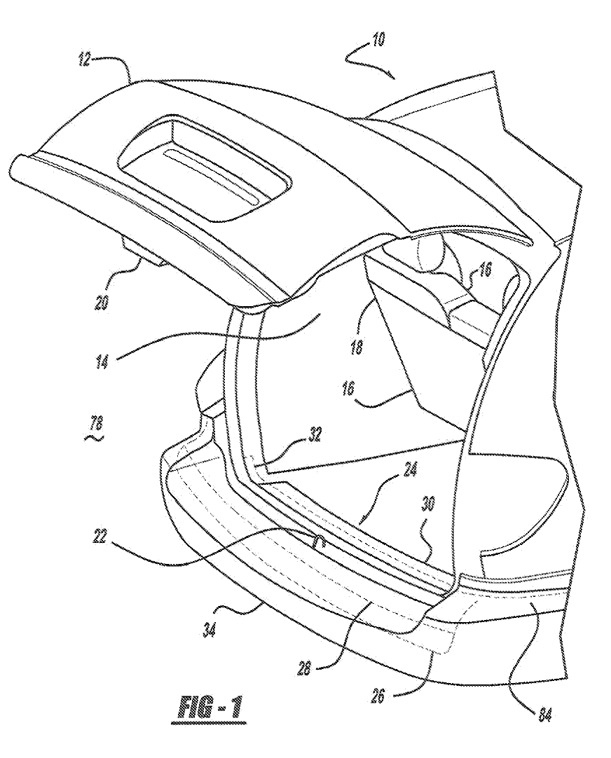

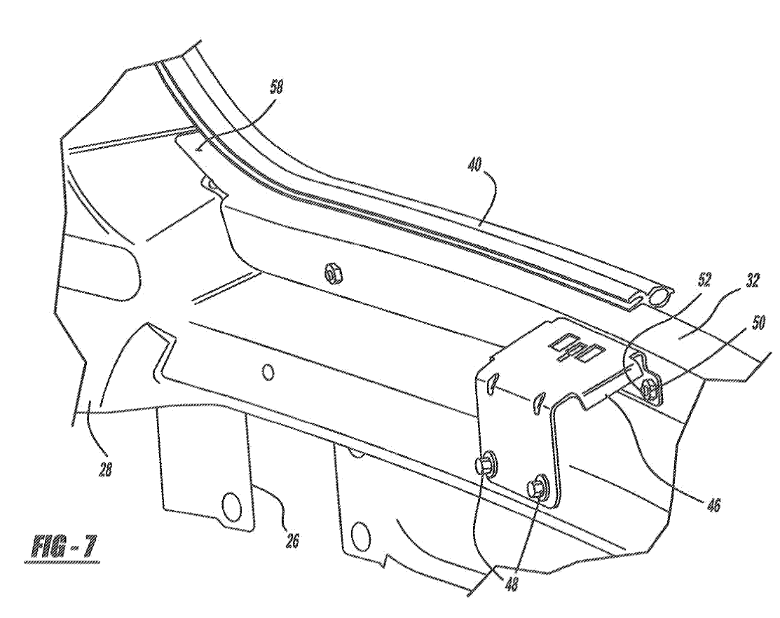

The following description of the preferred embodiment(s) is merely exemplary in nature and is in no way intended to limit the invention, its application, or uses. Turning now to FIG. 1, a rear perspective view of a vehicle 10 is depicted in which a liftgate 12 is in its open or upward position. The liftgate 12 defines the rearward boundary of an interior cargo volume 14 that is bounded by a seat back 16 of a rear seat 18. The liftgate 12 has a latch 20 that contacts and attaches to a striker 22 located in a striker area 24. The striker 22 is fastened to a striker mounting bracket 46 (FIG. 7) that is generally fastened to parts such as an outer closure panel 26, inner closure panel 28, scuff plate 30 and lip bracket 32, which are generally covered by a rear bumper 34.

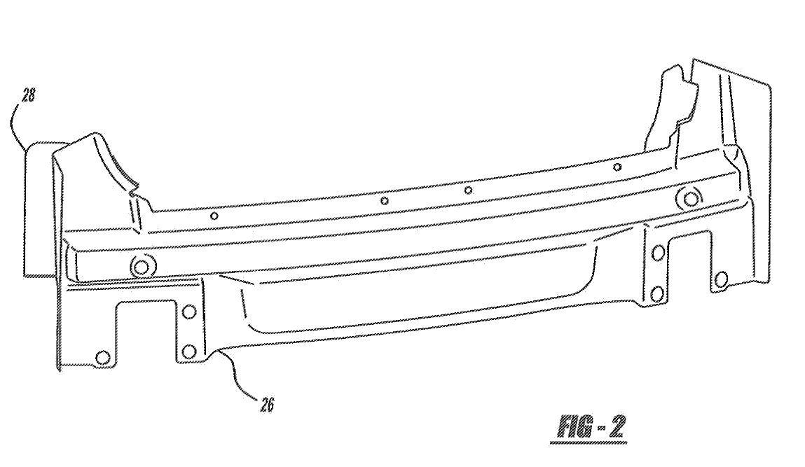

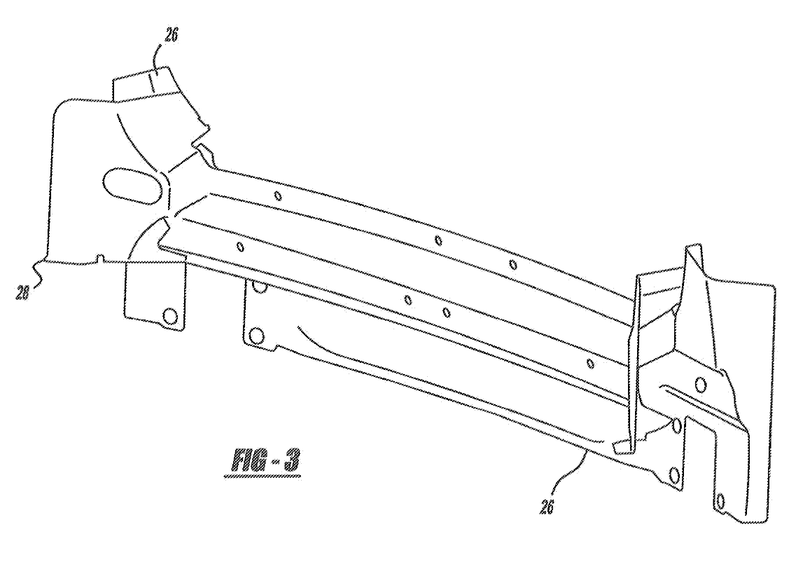

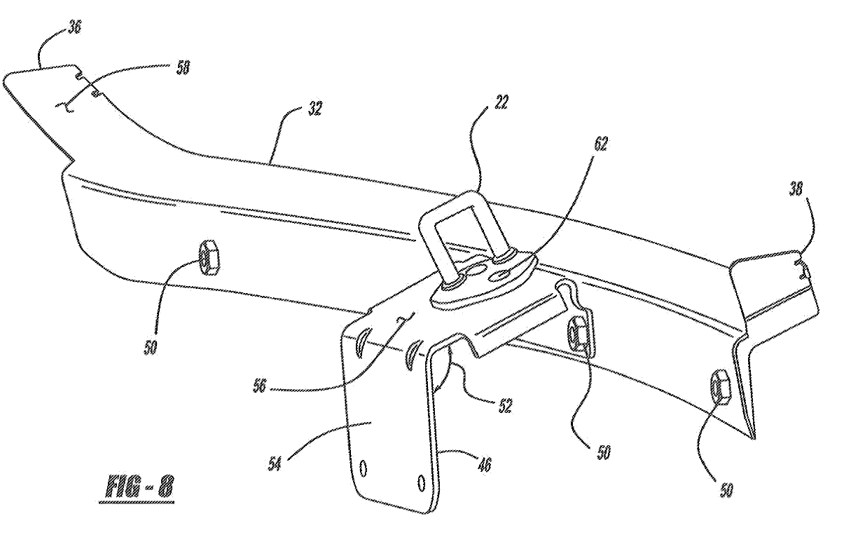

Further details of the invention will now be explained with the use of FIGS. 2-13. First, larger structural parts will be presented and then smaller, more detailed parts with be presented, both to exemplify examples of embodiments. Turning now to FIG. 2, an outer closure panel 26 and an inner closure panel 28 are depicted. The outer closure panel 26 is referred to as an “outer” panel because it is positioned toward an outside of the vehicle relative to the “inner” closure panel which is closer to the inside of the vehicle, or interior components of the vehicle 10. The outer and inner closure panels 26, 28 may be made from a metal material such as stamped steel to facilitate welding of the parts to each other or so that other parts may he welded to the outer and inner closure panels 26, 28. FIG. 3 depicts the inner and outer closure panels 28, 26 from the side of the inner closure panel 28.

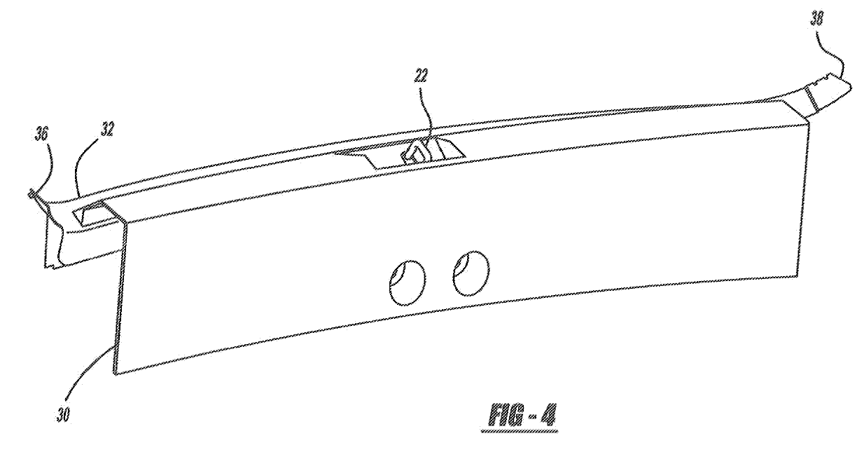

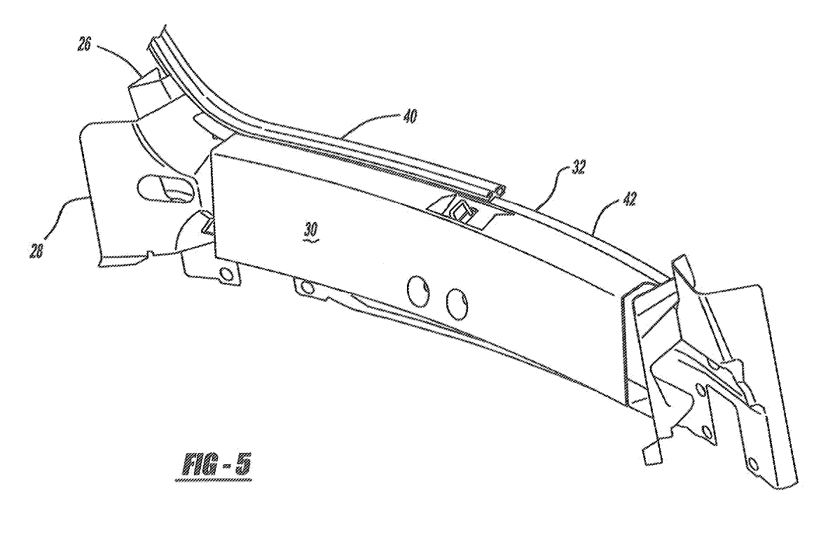

FIG. 4 is a perspective view from an inferior of a vehicle depicting a scuff plate 30 and a lip bracket 32 to which a weather seal may be applied. Continuing, a striker 22 is depicted, which protrudes through the scuff plate 30 at a specific angle to connect with the latch 20 of the liftgate 12. The scuff plate 30 may be a plastic material that is used as a general, aesthetic covering that covers the internal area of the vehicle 10 next to an interior surface of the liftgate 12. The scuff plate 30 affords a smooth surface to objects and cargo that may be slid into and out of the interior cargo volume 14. The lip bracket 32 may be a steel part with a first end tab 36 and a second end tab 38 that are welded to the inner closure panel 28 as depicted in FIG. 5. More specifically, FIG. 5 depicts an assemblage of the outer closure panel 26, inner closure panel 28, lip bracket 32 and scuff plate 30. As depicted in FIG. 4, the lip bracket 32 is attached between inner opposing faces of the scuff plate 30. Additionally, a weather seal 40 may be applied to a length of an edge 42 of the Hp bracket 32. The weather seal 40 may be made from a rubber material that compresses when contacted by the liftgate 12 to prevent noise, air, water, exhaust fumes, dust, etc. from entering at the juncture of the weather seal 40 and the liftgate 12. The weather seal 40 may be pressed onto the edge 42 of the lip bracket 32 using, for example, an interference fit.

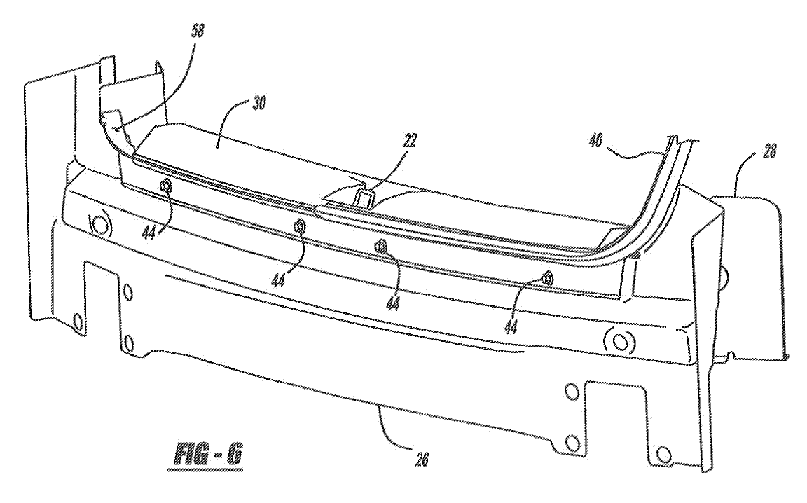

FIG. 6 is a perspective view from an exterior of a vehicle that depicts fasteners 44, as one example of a fastener, to secure the scuff plate 30 to the outer and inner closure panels 26, 28. Additionally, the scuff plate 30 is bolted to and thereby secured to the outer and inner closure panels 26, 28 and lip bracket 32. To improve rigidity of the connected outer and inner closure panels 26, 28 and the lip bracket 32, portions of the tip bracket 32, such as the first and second end tabs 36, 38 may be welded to the inner closure pane 28I, while the outer and inner closure panels 26, 28 may be welded to each other before being bolted. As depicted in FIG. 6, the striker 22 lies generally in the middle of the length of the scuff plate 30 while the fasteners 44 are evenly space along the length of the scuff plate.

FIG. 7 is a perspective view from an interior of a vehicle depicting a first striker mounting bracket 46 fastened to the inner closure panel 28. More specifically, the striker mounting bracket 46 is also mounted against the lip bracket 32. To secure the first striker mounting bracket 46, fasteners, one example being bolts 48, may be used that thread into the inner closure panel 28. Additionally, weld nuts 50 may be welded to the first striker mounting bracket 46 on either side of the striker mounting bracket 46 such that a corresponding bolt 52 may be place from the exterior side of the inner closure panel 28 and screwed into the threads of the weld nuts 50. Although not depicted in FIG. 7, a weld nut 50 may be located on each side of the first striker mounting bracket 46. The first striker mounting bracket 46 may have elongated mounting holes to permit adjustability of the striker 22 relative to a top plate 56 of the first striker mounting bracket 46. In another alternative, regular, traditional bolts and corresponding nuts may be used at the four locations of the striker mounting bracket 46 to secure the striker mounting bracket 46 in place. However, utilizing weld nuts 50 may save time as opposed to installing traditional loose bolts and nuts during assembly. Regardless of what fasteners or fastening method is used, the fasteners must present a relatively quick and easy way for more than one striker mounting bracket 46 to be utilized, given a particular vehicle underbody, which will now be explained.

FIG. 7-9 depict a first striker mounting bracket 46 that may be used to position a first striker 22, also known as a latch striker. The first striker 22 of the first striker mounting bracket 46 may be positioned at a first angle 52 relative to a vertical or nearly vertical component, such as a leg 54 of the first striker mounting bracket 46. The first angle 52 positions a top plate 56 of the first striker mounting bracket 46 at a specific angle to accommodate a closed position of a liftgate of a particular vehicle, such as the liftgate 12 of FIG. 1. Thus, the first striker mounting bracket 46, because of its flexibility to be fastened to the lip bracket 32 quickly and in a non-permanent fashion using threaded fasteners and threaded nuts 50, using different striker mounting brackets is possible during the vehicle assembly process, which is an advantage of the present teachings. Similar to the first striker mounting bracket 46 that is fastened using removable fasteners, the lip bracket 32 may also be fastened to the outer and inner closure panels 26, 28 using weld nuts; however, welding may also be used to weld the ends tabs 36, 38, such as at weld location 58 of the first end tab 36. The advantage of welding is that a non-removable, rigid connection is created.

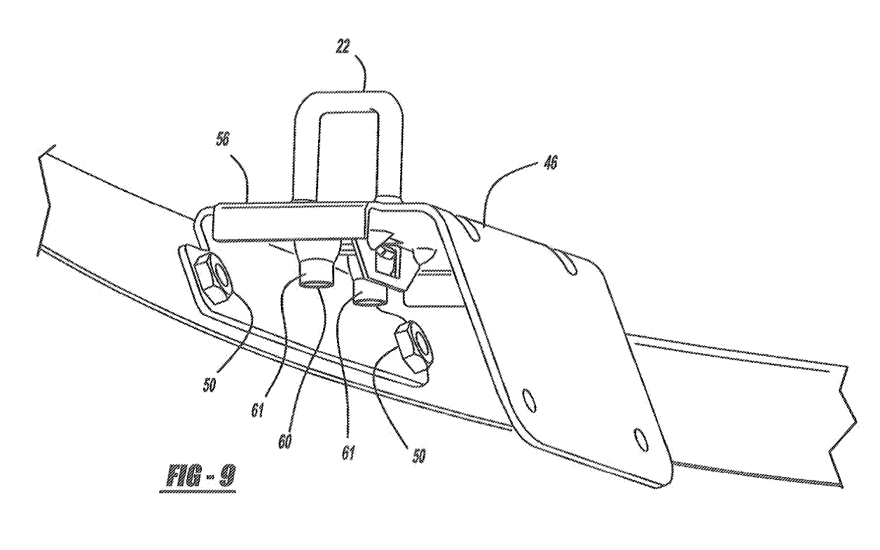

FIG. 9 is another perspective view from an inferior of a vehicle depicting a striker 22 and the first striker mounting bracket 46 fastened to the Hp bracket 32. Continuing, the first striker mounting bracket 46 has a bolt tapping plate 60 situated or positioned as its underside. The bolt tapping plate 60 has columns 61 with internal threads to accommodate traditional fasteners, such as threaded bolts. To secure the striker 22 to the top surface 66 of the first striker mounting bracket 46, threaded bolts (not shown) may be inserted through holes in the striker 22 and corresponding holes in the first striker mounting bracket 46 so that threads of the bolts engage the threads in the columns 61 of the bolt tapping plate 60. Thus, the striker 22 may be firmly secured on the first striker mounting bracket 46 for contact with the latch 20 of the liftgate 12. Because the holes in the first striker mounting bracket 46 may be elongate, the bolt tapping plate 60 may be adjusted on the underside of the first striker mounting bracket 46 to correspondingly adjust the position of the striker 22. Such adjustment may be necessary to satisfactorily permit a liftgate to properly close and latch.

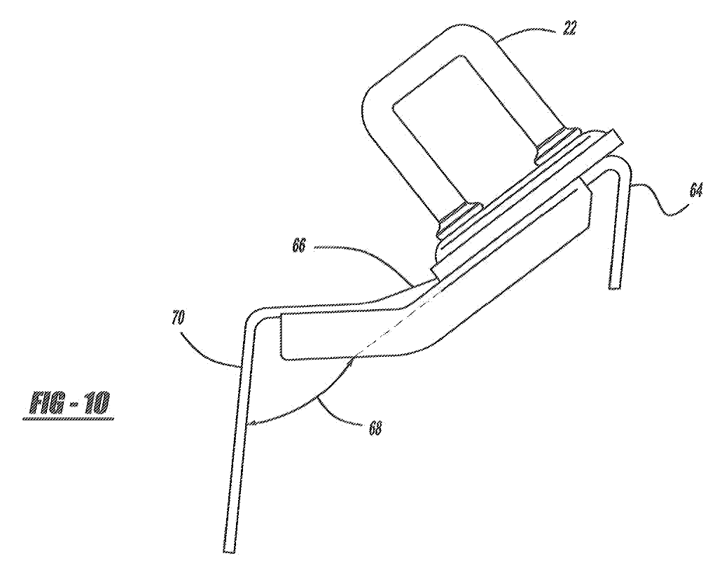

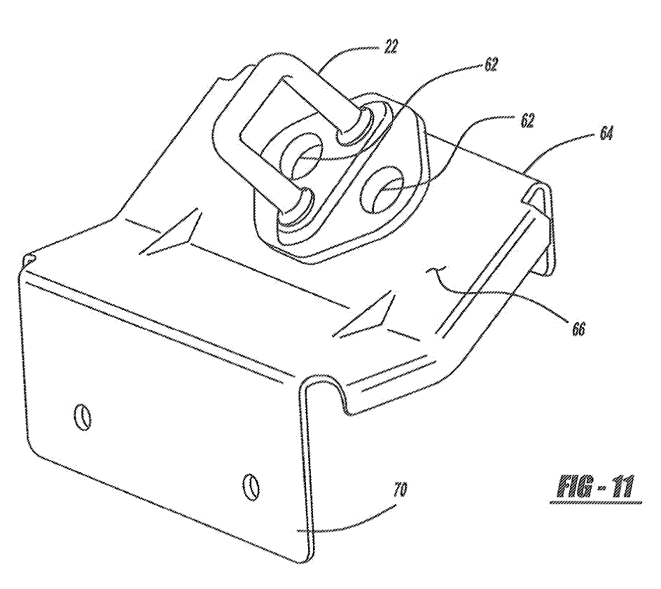

FIG. 10 is a side view of a second striker mounting bracket 64 and striker 22. It is noted that the striker 22 mounted upon the first striker mounting bracket 46 may be the same striker as that mounted on the second striker mounting bracket 64. Continuing, the fop surface 66 forms an angle 68 with a vertical component or nearly vertical component, such as leg 70, that is different from the angle 52 of the first striker mounting bracket 46 and a top surface of its top plate 56. FIG. 11 is a perspective top view of the second striker mounting bracket 64 and striker 22 mounted to a fop surface 66. FIG. 11 also depicts holes 62 in the top surface 66 and in the striker 22 that are used to mount the striker 22 to the second striker mounting bracket 64.

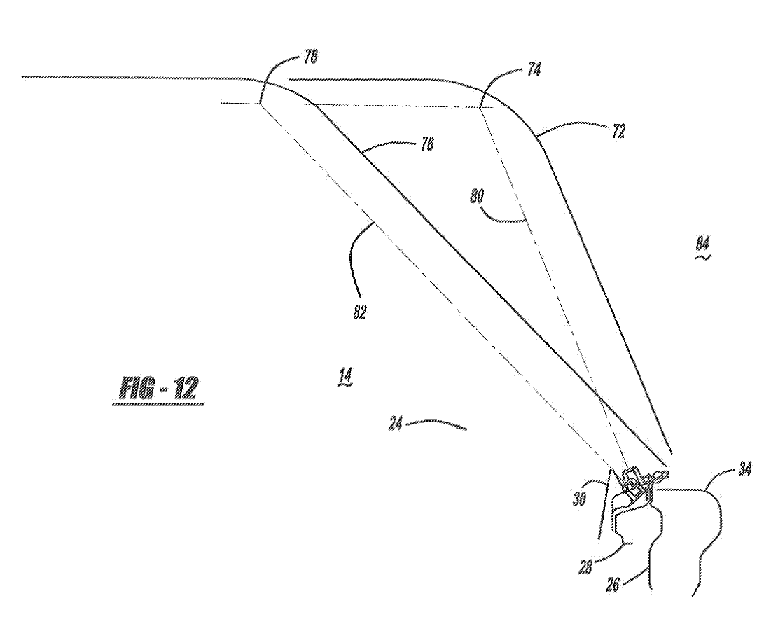

FIG. 12 depicts general relative positions regarding the first and second striker mounting brackets 46, 64 and their corresponding striker 22 in the striker area 24 and will be used to exemplify an advantage of the teachings. FIG. 12 depicts a first liftgate 72 having a first pivot location 74 and a second liftgate 76 having a second pivot location 78. Between the first pivot location 74 and the striker 22 of the first liftgate 72, a straight line may be drawn as depicted by a dashed line 80. Likewise, between the second pivot location 78 and the striker 22 of the second liftgate 76, a straight line may be drawn as depicted by a dashed line 82. FIG. 12 also depicts the scuff plate 30, at an inferior 14 of a vehicle, a bumper fascia 34 at an exterior 84 of a vehicle, and the outer and inner closure panels 26, 28 between such pieces,

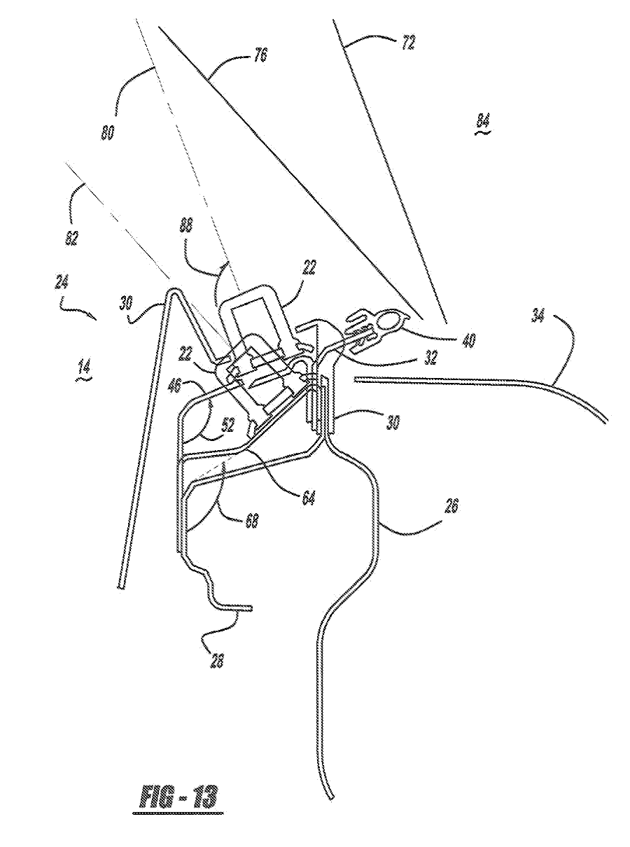

FIG. 13 depicts an enlarged view of the striker area 24. More particularly, FIG. 13 depicts the relative positions of the first striker mounting bracket 46 and the second striker mounting bracket 64 and the accompanying striker 22. While FIG. 13 depicts both, the first striker mounting bracket 46 and the second striker mounting bracket 64, only one is installed at any one time on a vehicle. By depicting both, one can see that either the first striker mounting bracket 46 or the second striker mounting bracket 64 may be mounted to the outer closure panel 26 and inner closure panel 28. Such flexibility of being able to select different striker mounting brackets 48, 64 permits different liftgates 72, 76 to be mounted to the same vehicle underbody 86 or chassis (FIG. 1).

Continuing with FIG. 13, by utilizing the same vehicle underbody 86, also known as a chassis or vehicle platform, for different body styles, such as a minivan, crossover and sport utility vehicle (“SUV”) body styles, for example, a vehicle manufacturer can greatly increase production output for a given period of time. The increase, is in part due to the reduction of time that may normally have to be spent to change tooling to accommodate a different vehicle platform. Because the outer and inner closure panels 26, 28 mount to the vehicle underbody 86 or chassis, either directly or indirectly, an economy of scale can be achieved by only fastening a different striker mounting bracket 46, 64 to the inner closure panel 28. With different striker mounting brackets, respective strikers for each striker mounting bracket may be mounted at different angles, relative to the ground upon which a vehicle rests, to accommodate the respective approach angle that a selected liftgate requires for proper closing upon its striker. The approach angle of a liftgate is that angle formed by the straight line drawn between the liftgate pivot location and the striker, and the top of the striker, as depicted in FIG. 13 with approach angle 88, for example.

Upon utilization of the first striker mounting bracket 46, a different scuff plate than the scuff plate 30 as shown fastened around the second striker mounting bracket 64, may be utilized. The first and second striker mounting plates 46, 64 each have a set of opposing flanges, also referred to as legs, that are vertical or approximately vertical and fasten to the inner closure panel 28. By keeping the distance between opposing flanges or legs of the first striker mounting plate 46 the same or nearly the same as the distance between opposing flanges or legs of the second striker mounting plate 46, interchangeability is ensured as each plate 46, 64 will easily be fastenable to the inner closure panel 28. As depicted in FIG. 13, a portion of the scuff plate 30 may lie between either the first or second striker mounting plate 46, 64 and the inner closure panel 28 when fastened with a fastener (not shown). While the Invention has been described as being able to accommodate different liftgates, each having a different pivot location and thus a different approach angle, a single liftgate may be utilized but have different approach angles relative to the striker 22. Such may be the case when a different pivot location is utilized with the same liftgate, possibly for different vehicle body styles.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vehicle scuff plate assembly comprising:
an outer closure panel;
an inner closure panel fastened to the outer closure panel;
a first striker mounting bracket fastenable to the inner closure panel;
a first striker fastened to the first striker mounting bracket;
a second striker mounting bracket fastenable to the inner closure panel;
a second striker fastened to the second striker mounting bracket; and
a scuff plate fastened to the outer closure panel that surrounds the first striker.

2. The vehicle scuff plate assembly of claim 1, wherein the first striker mounting bracket has elongated mounting holes to permit adjustability of the first striker relative to a fop surface of the first striker mounting bracket.

3. The vehicle scuff plate assembly of claim 2, wherein the first and second striker mounting brackets are interchangeable and the second striker mounting bracket is configured to orient the second striker in a different position from the first striker.

4. The vehicle scuff plate assembly of claim 3, further comprising:
a vehicle underbody, wherein the inner closure panel and outer closure panel both fasten to the vehicle underbody.

5. A vehicle scuff plate assembly comprising:
an outer closure panel;
an inner closure panel fastened to the outer closure panel;
a first striker mounting bracket fastenable to the inner closure panel;
a first striker fastened to the first striker mounting bracket;
a second striker mounting bracket fastenable to the inner closure panel; and
a second striker fastened to the second striker mounting bracket, wherein the first and second striker mounting brackets are interchangeable to accommodate different vehicle liftgate approach angles.

6. The vehicle scuff plate assembly of claim 5, further comprising:
a scuff plate fastened to the outer closure panel that surrounds either the first or the second striker, wherein the first and second striker mounting plates each have a set of opposing flanges fastenable to the inner closure panel.

7. The vehicle scuff plate assembly of claim 6, further comprising:
a steel lip disposed around the scuff plate; and
a seal attached along an edge of the steel lip.

8. The vehicle scuff plate of claim 7, wherein the first striker forms a first angle with a vertical plane that is different from a second angle formed by the second striker with the vertical plane.

9. The vehicle scuff plate assembly of claim 7, further comprising a liftgate, wherein the liftgate is pivotable from a first pivot location when the first striker mounting bracket is fastened to the inner closure panel, and from a second pivot location when a second mounting bracket is fastened to the inner closure panel.

10. A vehicle scuff plate assembly comprising:
an outer closure panel;
an inner closure panel fastened to the outer closure panel;
a first striker mounting bracket fastenable to the inner closure panel;
a first striker fastened to the first striker mounting bracket;
a second striker mounting bracket fastenable to the inner closure panel;
a second striker fastened to the second striker mounting bracket; and
a liftgate pivotable about a pivot location, wherein the first and second striker mounting brackets are interchangeable and fastenable to the inner closure panel to accommodate different pivot locations of the liftgate.

11. The vehicle scuff plate assembly of claim 10, further comprising a scuff plate fastened over lengths of the outer closure panel and the inner closure panel.

12. The vehicle scuff plate assembly of claim 11, further comprising:
a lip fastened between opposing inner faces of the scuff plate; and
a seal attached along an edge of the lip.

13. The vehicle scuff plate assembly of claim 12, wherein the first and second striker mounting plates accommodate different approach angles of the liftgate.

14. The vehicle scuff plate assembly of claim 13, wherein the seal is a rubber weather seal.
